(19) United States
(12) Patent Application Publication
(10) Pub. No.: US 2007/0278798 A1
(43) Pub. Date: Dec. 6, 2007

(54) Way to increase the power of a windmill by 10 to 20 times

(76) Inventor: Hanna Albert Awad, Ajaltoun (LB)

Correspondence Address: HANNA ALBERT AWAD, AJALTOUN, KESROVAN, LEBANON, AJALTOVN, KESROVAN, omitted

(21) Appl. No.: 11/444,462

(22) Filed: Jun. 1, 2006

(51) Int. Cl. F03D 9/00; H02P 9/04

(52) U.S. Cl. 290/55

(57) ABSTRACT

In order to increase the power generated by a windmill by 10 to 20 times, you will have to increase the number of wheel by 10 to 20 times on both sides of the post.

The wheels will be welded to the same shaft that turns to generate power.

The wheels and the shaft will be similar to an air turbine.

In order to increase the power generated by a windmill by 10 to 20 times, you will have to increase the number of wheel by 10 to 20 times on both sides of the post.

The wheels will be welded to the same shaft that turns to generate power.

The wheels and the shaft will be similar to an air turbine.

1. A way to increase the power of a windmill by 10 to 20 times which will be done by increasing the number of wheels by 10 to 20 times welded to the same shaft on both sides of the post and this will be similar to an air turbine
